(19) United States
(12) Patent Application Publication
(10) Pub. No.: US 2024/0069525 A1
(43) Pub. Date: Feb. 29, 2024

(54) MACHINING PARAMETER RECOMMENDATIONS USING IN-PROCESS MACHINING DATA AGGREGATION

(71) Applicant: UT-Battelle, LLC, Oak Ridge, TN (US)

(72) Inventors: Jaydeep Karandikar, Oak Ridge, TN (US); Junghoon Chae, Oak Ridge, TN (US); Kevin Scott Smith, Oak Ridge, TN (US); Tony Schmitz, Oak Ridge, TN (US); Chad Steed, Oak Ridge, TN (US)

(21) Appl. No.: 18/239,438

(22) Filed: Aug. 29, 2023

Related U.S. Application Data
(60) Provisional application No. 63/402,110, filed on Aug. 30, 2022.

(51) Int. Cl. G05B 19/4155

(52) U.S. Cl. CPC G05B 19/4155; G05B 2219/33099

(57) ABSTRACT

Historical in-process machining information can be used to make machining process parameter recommendations. The disclosed systems and methods enable continuous learning for machining parameter selection using aggregated in-process machining information. The systems and methods save in-process machining data in a database using a standardized format, use data augmentation outlier detection, aggregation, and clustering algorithms to make machining process parameter recommendations and expected cut time predictions based on user inputs. The system can include a front-end dashboard to facilitate visualization and interpret results.

This invention was made with government support under Contract No. DE-AC05-00OR22725 awarded by the U.S. Department of Energy. The government has certain rights in the invention.

### BACKGROUND OF THE INVENTION

The present disclosure relates to machining parameter recommendations.

For machining a given material, the programmer/process engineer makes various decisions regarding (i) a tool, e.g., supplier, geometry, and grade, (ii) a tool path, (iii) process parameters, e.g., cutting speed, feed rate, and depth of cut, (iv) coolant type and delivery method, and (v) a fixture to hold the part. For a given material, there are many alternatives for cutting tools and a wide range of feasible process parameters. To illustrate, for turning nickel-based superalloys, tool supplier Sandvik has five carbide grades, e.g., S205, S05F, GC1105, GC1115, and GC1125, and four ceramic grades, e.g., CC6060, CC6165, CC6160, CC670. Similarly, other tooling vendors such as Kennametal, Seco, Greenleaf, and Iscar have multiple grades in carbide and ceramic materials for turning nickel-based superalloys. For each insert grade, there is a wide range of feasible process parameters for a given material and operation. For example, for carbide grades, the recommended cutting speed for rough turning Inconel 718 is between 150 Surface Feet per Minute (sfm) (45 meters/min)-250 sfm (76.2 m/min), while the recommended cutting speed for ceramic inserts is 600 sfm (182.88 m/min)-1200 sfm (365.76 m/min).

For a given machining operation, the engineer generally chooses a suitable insert geometry and grade, and the process parameters to minimize the total machining cost. Although analytical, empirical, or hybrid models exist to predict machining process performance, e.g., such as machining stability and tool wear, challenges remain. For example, modeling machining stability needs information on the tool point frequency response function, which needs an instrumented hammer, accelerometers, and a data acquisition system. Tool wear models need experimentation for calibrating the model coefficients, which is infeasible for many tool-material combinations. Furthermore, there is uncertainty due to factors that are not included in the model or not known. As a result, pre-process identification of suitable tool and process parameters in machining is difficult. Therefore, machining parameter selection is typically done using experience, manufacturer, or handbook recommendations, and is often overly conservative. Furthermore, any optimization is typically done using trial and error.

A conventional technical solution that addresses in part some of the above-noted technical challenges was described in U.S. Pat. No. 10,564,624 entitled “Optimal machining parameter selection using a data-driven tool life modeling approach”, This reference describes an iterative method for optimizing a machining process considering trade-offs in tool wear and cycle time. The noted conventional method can be used to optimize a particular feature for a given machine, tool, and material combination and can be used to build a data-driven probabilistic model for tool life and an iterative optimization strategy to converge to the optimal process parameters. Further, the conventional method can use flank wear data to build a tool life model. However, this conventional method is restricted to optimizing a particular application, e.g., machine-tool-material. It does not use data aggregation or augmentation methods to recommend near-optimal starting parameters for a given setup and tool-material combination. Additionally, the conventional method does not provide recommendations on tools and starting parameters for a new application for a given machine and material combination.

### SUMMARY OF THE INVENTION

The present disclosure provides systems and methods for machining parameter recommendation. In one embodiment, a machining parameter recommendation system for use with a CNC machine to recommend machining parameters for a given machine and material combination is provided. The system includes a machining information database for storing machining information for various machine and material combinations and a user interface configured to receive a machining parameter recommendation request from a user. The machining parameter recommendation request identifies a machine and a material. Depending on the configuration of the system, the request may be configured to recommend starting machining parameters for a given material and machine combination or to provide recommended machining parameters to meet a particular machining objective (e.g., cycle time reduction, productivity improvement, tool cost reduction, improved tool life, and/or total cost reduction, which considers trade-off between cycle time and tool life).

The machining parameter recommendation system can include a controller configured to receive a machining parameter recommendation request from a user interface. The controller can request and receive machining information from the machining information database related to the machine and the material identified in the machining parameter recommendation request, determine a set of recommended machining parameters, and communicate the set of recommended machining parameters to the user interface and/or, in some embodiments directly to a CNC machine.

The methodology of the machining parameter recommendation controller includes filtering the received machining information based on the user machining parameter recommendation request to a set of filtered machining information related to the machine and material identified in the machining parameter recommendation request. The controller can detect outliers in this filtered machining information and remove any detected outliers to obtain corrected machining information. The outlier detection can leverage one or more of median absolute deviation, elliptic envelope, isolation forest, or local outlier factor machine learning algorithms.

The machining information can be clustered and aggregated in accordance with the machining parameter recommendation request. This can include utilizing one or more clustering and aggregating algorithms, such as K-means, mean-shift clustering, or expectation-maximization (EM) clustering using Gaussian mixture models. Once a suitable set of recommended machining parameters are obtained from the clustering and aggregation, those recommendations can be communicated to the user interface and/or to a CNC machine for controlling the machine accordingly.

After filtering the machining parameter information based on the machining parameter recommendation request, the amount of machining information may be too small for suitable clustering and aggregation. Accordingly, the controller can augment the machining information with additional machining information from the database that is unrelated to the machining information in some way (e.g., different material, different machine, different grade, etc.). This augmentation can include adjusting the additional machining information based on a calculated compensation factor.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 illustrates an exemplary representative diagram of a system for recommending machining parameters in accordance with the present disclosure.

FIG. 2 illustrates an exemplary flowchart of a method for recommending machining parameters in accordance with the present disclosure.

FIG. 3 illustrates exemplary process parameter clusters using representative data for machining Inconel 718.

### DESCRIPTION OF THE CURRENT EMBODIMENT

Systems and methods for recommending machining parameters in accordance with the present disclosure can utilize data aggregation and/or data augmentation to recommend suitable starting parameters for a given setup and tool-material combination. Further, some embodiments can provide recommendations on tools and starting parameters for a new application for a given machine and material combination.

Embodiments of the present disclosure do not need access to tool wear information or tool life models to make suitable recommendations. Instead, the disclosed embodiments utilize continuous learning methods for machining parameter selection using aggregated in-process data. For example, the disclosed embodiments, can include one or more of the following modules:
a collection module configured to save in-process machining data in a database using a standardized format;
a recommendation module configured to use data augmentation, outlier detection, aggregation, and clustering submodules that execute algorithms for analyzing data and making process parameter recommendations and expected cut time predictions based on user inputs.
a front-end dashboard module to visualize raw data and interpret results.

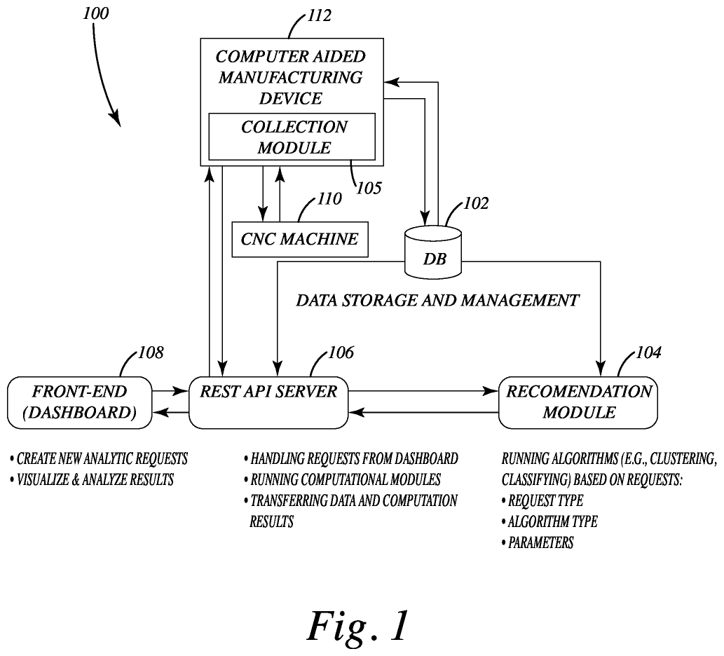

An exemplary system in accordance with the present disclosure is illustrated diagrammatically in FIG. 1. The system 100 includes a front-end dashboard 108, a machining information database 102, and a server 106 (e.g., a REST API server). The server 106 can be a data processing apparatus that include memory. The memory can include instructions that when executed by the server they cause the server to perform a variety of different operations, such as receiving machining information from a user, accessing machining information from the database, and executing machining parameter recommendation application submodules. These submodules include instructions stored in memory to run algorithms (e.g., filtering, augmenting, clustering, classifying) based on requests from the server. The requests can identify a request type, an algorithm type, and a set of machining parameters. The server 106 can handle requests to and from the dashboard 108, the recommendation module 104, the collection module 105, the machining database 102, and, in some embodiments, one or more CNC machines 110. The server can run the recommendation and collection module software locally or in a distributed fashion across one or more separate devices. That is, in some embodiments, the recommendation module and collection module can modules configured in memory of standalone devices, instead of modules configured in memory of the server, that can communicate with other devices in the system (e.g., front-end dashboard 108, server 106, and the database 106). In the exemplary depicted embodiment of FIG. 1, the collection module 105 resides in a separate computer aided manufacturing device 112 while the recommendation module 104 and its submodules reside in memory on the server 106. Alternative embodiments can have a different composition and/or arrangement of components.

In some embodiments, the system does not communicate directly with the CNC Machine 110 that will use the recommended parameters. Instead, the recommended parameters are processed by Computer Aided Manufacturing (CAM) software, which generates a machine toolpath and G-code. The user can manually enter the recommended parameters obtained from the front-end dashboard or alternatively, the dashboard or server can send the recommended parameters to a CAM computer (e.g., via the server 106 or directly), running the CAM software. The generated G-code based on the recommended parameters can then be communicated to the CNC Machine from the CAM computer, i.e., the device running the CAM software as shown in FIG. 1.

Database—Data Storage and Management

The disclosed embodiments include collecting in-process machining data and saving it in a standardized format in a data storage and management module, often referred to as a database 102. A database is a structured system designed to efficiently store, organize, retrieve, and manage large volumes of data. In general, a database includes structured data stored in table where each table contains rows and columns. Each row represents a record, and each column represents a specific attribute or piece of information associated with that record. This tabular structure facilitates organization and retrieval of data.

The database 102 can be relational or non-relational (e.g., object-oriented). In general, relational databases use a structured query language to manage and retrieve data. They establish relationships between tables using keys, such as primary keys and foreign keys. Non-relational databases provide more flexible data models and are suitable for handling large amounts of unstructured or semi-structured data.

The data stored in the database can include, for example, the following types of information:
Machine information (e.g., make, model, and year)
Material information (e.g., International Standards Organization (ISO) group, name, and hardness)
Coolant information (e.g., coolant type and delivery method)
Tool holder information
Type of cut information (e.g., interrupted/uninterrupted and a qualitative degree of interruption such as high, medium, and low)
Tool information (e.g., supplier, geometry, grade, and chip breaker)
Process parameters: cutting speed, feed rate, and depth of cut
Cut time
Parts per insert/tool edge

In some implementations, data collection can be done manually by an engineer or other user and manually entered in the front-end dashboard 108. In other implementations, data collection can be conducted automatically by in-process data collection. For example, a new analytic request at the front-end 108 can be communicated (directly or indirectly) to the machining system, which can provide the relevant information. In addition, or alternatively, data collection can be conducted automatically by an external machine monitoring device and the data can be stored in the database. In some implementations, a hybrid approach may be utilized where some information is entered manually and other information is provided over a communication network from the machining system. The collected data can be stored in a database 102.

The schema of the database can be flexible to support situations including new value ranges and types. For instance, PostgreSQL can be used as a database management system. PostgreSQL is an object-relational database. An object-relational database is a type of database management system that combines features from both relational databases and object-oriented databases. In general, it bridges the gap between the structured tabular nature of relational databases and the more complex data structures and behaviors found in object-oriented programming. In an object-relational database, not only simple data types like integers and strings can be stored, but also more complex data structures such as objects, arrays, and user-defined data types. This allows real-world entities to be modeled more closely, which is particularly useful for applications that deal with complex data relationships and behaviors, such as analyzing machining parameters. Use of a suitable database enables more complex data types and allows objects to inherit properties.

Checks can be added to ensure consistency in data format and accuracy. For example, the computational modules can be programmed or configured such that:
information about the machine, material, and tool can be compared to a pre-compiled list to ensure a standard format.
obsolete tool grades or geometries can be marked by comparing with the current tool list from the supplier and the data can be flagged or discarded. Limits can be based on experience, and supplier recommendations, and can be regularly updated. Furthermore, insert grades that have become obsolete can be periodically flagged.
numerical entries can ensure accuracy and reduce mistakes. For instance, a maximum value for depth of cut for a given insert geometry can be used to prevent values greater than the maximum depth of cut. Similarly, minimum, and maximum values can be used for cutting speed, feed rate, and cut times for different tool and material combinations.

The checks can be implemented by a processor on the server 106. For example, before executing any given computational module, a pre-check can be conducted (e.g., to ensure the data being provided to the module is in a suitable (e.g., standard) format for that module, to ensure no data related to obsolete tool grades or geometries is being provided to the module, and to ensure the range of values are suitable for cutting speed, feed rate, and cut times for different tool and material combinations). Information related to these checks can be relayed to the user via the front-end dashboard 108.

Application Submodules

Historic in-process machining data aggregation can be used to recommend process parameters for various application submodules 104. There can be a variety of different submodules 104 to recommend machining parameters for various situations.

1. Starting Machining Parameter Recommendation Application Submodule for a New Application

A user can input information on the machine, material, coolant, and type of cut using the front-end dashboard interface 108. User constraints can be provided as well, e.g., preferred tool supplier(s) and number of recommendations to be provided by the system (e.g., the system can be constrained to provide its top five results). Part of the submodule is a data analysis algorithm that can recommend a suitable tool, e.g., supplier, geometry, and grade; cutting parameters, e.g., cutting speed, feed rate, and depth of cut; and expected cut time. The recommendations can provide near-optimal starting machining parameters for the given inputs. By way of example, this exemplary module can provide a recommendation for a tool to last for a threshold time (e.g., in minutes) at a given set of cutting parameters.

2. Application Objective Machining Parameter Recommendation Application Submodule.

Another submodule recommends a tool based not only on the aggregated data in the database, but based on data provided by the end user about the current application (e.g., current tool, material, coolant, and type of cut along with the cutting parameters and cut time). In this way, the front end provides an interface for the user define how productivity improvement goals and/or tool cost reduction goals. That is, the user can define certain recommendation restrictions (e.g., same cut time with a cheaper tool, or the tool lasts longer but might be more expensive).

With this module, a user can input information on the machine, material, coolant, type of cut, current cutting parameters, cut time, parts per tool/insert edge, machine rate, tool/insert edge cost, tool change time, process objective, constraints, or some combination thereof. Process objectives can include cycle time reduction or productivity improvement; tool cost reduction or improved tool life; and/or total cost reduction, which considers trade-off between cycle time and tool life. Constraints can include preferred tool suppliers, minimum and maximum values for cutting parameters, cut times, and parts per tool edge.

Another data analysis algorithm can recommend optimal tool, e.g., supplier, geometry, and grade; cutting parameters, e.g., cutting speed, feed rate, and depth of cut; expected cut time; and expected improvement in process objective. The goal of this analysis is to improve the process for the desired process objective.

Methods for Machining Parameter Recommendation

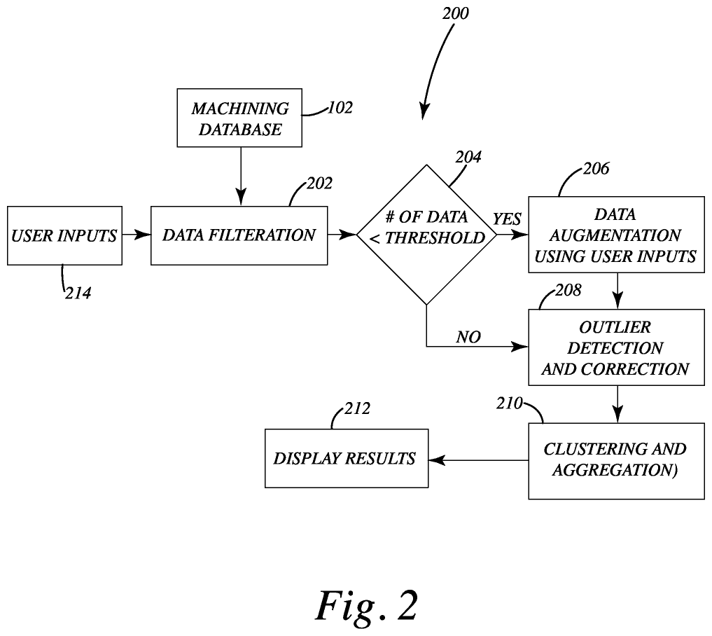

The methods for recommending machining process parameters 200 can include data filtration 202, clustering and aggregation 210, augmentation 206, and outlier detection 208, as shown in FIG. 2. In-process data, that is data that is collected during the machining process and stored in the machining database 102, can be used to facilitate machining parameter recommendations using data clustering and aggregation methods based on user inputs. Two exemplary application submodules (starting parameter recommendations for a new machining application, and objective based machining parameter recommendations) were mentioned above and will now be described in connection with the overall method for recommending and displaying machining process parameters 212.

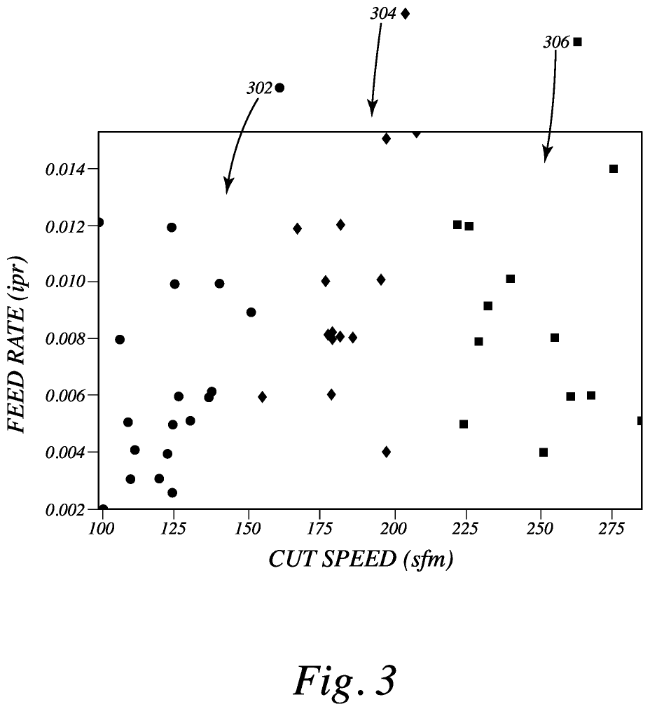

The data can be filtered 202 and potentially augmented 206 (if sufficient augmentation data is available 204) using user inputs 214 for whichever application module is being utilized. Then, the filtered data can be used to recommend the requested parameters using data clustering and aggregation methods 210. In many situations, the number of dimensions, sometimes referred to as features, of the subject data may be too high to cluster manually. Accordingly, a clustering algorithm can be utilized to identify meaningful groups and similar data points for each group. Different clustering methods such as K-means, mean-shift clustering, or Expectation-Maximization (EM) clustering using Gaussian Mixture Models can be used. To illustrate, FIG. 3 shows three clusters for cutting speed (surface feet per minute, sfm) and feed rate (inches per revolution, ipr) for representative data on machining Inconel 718 using a carbide grade insert on a continuous cut with coolant.

This in-process data may be collected from different machines at different manufacturing locations on different tool paths. Each data point (302, 304, 306) has an associated depth of cut and cut time, which are not represented in FIG. 3 to keep the graphic simpler for discussion purposes. As shown in FIG. 3, three different clusters have been identified (dot data points 302, diamond data points 304, and square data points 306). Additional machining parameters such as the depth of cut, cut time, and tool geometry may also be included in the data clustering. The distribution of the cut time and cutting parameters for each cluster group can be calculated. Recommendations can be made using average values or a certain percentile based on the number of data points for each of the clusters.

This clustering process and the recommended parameter calculations can be completed for every insert grade for the user selected material in the database. The insert grade recommendations can be subsequently sorted using maximum material removal rate (in³/min) or total material removal (in³), calculated as the product of the material removal rate and the cut time. If the user has a preferred vendor constraint, insert grades from the user's preferred vendor are given priority in the recommendations.

For the starting machining parameter recommendation application submodule, the disclosed clustering process enables identifying different parameter zones and provides recommendations based on the user's objectives. This clustering process enables continuous improvement as tests are completed with different process parameters for a given tool-material combination. The disclosed clustering process can also be used to compare inserts and grades from different suppliers and recommend tools based on the user objectives. This clustering process can also be used to compare machinability between different materials. In essence, this application submodule leverages the in-process data collected to provide starting machining parameter recommendations (e.g., tool, cutting parameters, and expected cut time) based on user inputs (e.g., machine, material, coolant, and type of cut) along with any user constraints (e.g., preferred tool supplier(s) and number of recommendations to be provided by the system). Part of the submodule is a data analysis algorithm that can recommend near-optimal starting machining parameters for the given inputs. By way of example, this exemplary module can provide a recommendation for a tool to last for a threshold time (e.g., in minutes) at a given set of cutting parameters

For the objective machining parameter recommendation application submodule, the baseline cost per part can be calculated using user inputs. The cost per part equation is shown below:

$${c}_{p} = {t}_{c} {r}_{m} + \frac{{t}_{ch} {r}_{m}}{{p}_{te}} + \frac{{c}_{te}}{{p}_{te}} \qquad ( 1 )$$

In Eq. 1, cₚ is the cost per part in $, t_{c} is the cut time per part in minutes, rₘ is the machine rate in $/min, t_{ch} is the tool change time or insert index time in minutes, cₜₑ is the cost per tool/insert edge in $, and pₜₑ is parts per tool edge. For each insert grade, the optimal cost per part is determined. For a selected insert grade, the cost per part can be calculated for the different clusters using the process parameters and the associated cut times. The optimal cost per part is the minimum value from the different clusters. The insert grades can be sorted based on the user objectives, e.g., cycle time reduction, tool cost reduction, or total cost reduction, and the constraints.

Data Filtering and Augmentation

Filtering data with user inputs can result in a small number of data points. To address this, a data augmentation method 206 can be applied if the number of filtered data is below a pre-determined number 204, as shown in FIG. 2. Data augmentation 206 can be completed in the following manner. A cut time compensation factor for user parameters can be used to convert existing data to match user inputs. The compensation factor can be calibrated using empirical data, experiments, literature reviews, physics-based modeling approaches, or a combination thereof. To illustrate, consider a case for the starting parameter application submodule where the user inputs are:
Material: 1040 steel
Coolant: Yes (e.g., the cutting zone is flooded with coolant during the cutting process)
Interruption: Yes

There may exist a few data points in the database for an interrupted cut with coolant on 1040 steel. As a result, filtering the database using the interrupted cut input may result in a few data points, less than the threshold number for efficient clustering. In that case, the data can be augmented by using the data for continuous cuts, e.g., with no interruption. This can be done by adjusting the cut time in the database for continuous cuts to reflect cuts with interruption using a compensation factor.

$${t}_{{c}_{c}} = \frac{{t}_{{c}_{i}}}{{α}_{i}} \qquad ( 2 )$$

In Eq. 2, t_{c}_{_{c}} denotes the cut time for a continuous cut, αᵢ denotes the compensation factor to adjust the cut time due to interruption, and t_{c}_{ᵢ} denotes the cut time for an interrupted cut. From machining physics, the cut time can be less for an interrupted cut than for a continuous cut. Therefore, the α_{ci}<1. Additional compensation factors can be added for the degree of interruption, e.g., low, medium, high. Eq. 2 can be used to adjust the cut time for data in the database to match the user inputs for the cut interruption. Similarly, from machining physics, the cut time can be reduced without coolant.

$${t}_{{c}_{co}} = \frac{{t}_{{c}_{d}}}{{α}_{c}} \qquad ( 3 )$$

In Eq. 3, t_{c}_{_{d}} denotes the cut time for dry conditions, e.g., without coolant, α_{c} denotes the compensation factor to adjust the cut time for removing coolant, resulting in dry cutting, and t_{c}_{_{co}} denotes the cut time with coolant. Note that, in Eq. 3, α_{c}<1. Furthermore, the delivery of the coolant, e.g., high-pressure or flood, will also affect the cutting temperatures, and therefore the cut time. An additional compensation factor may be defined for different coolant delivery methods, e.g., through-tool, high pressure, flood.

For depth of cut compensation, a power-law equation can be used to adjust the cut time.

$${t}_{{c}_{b}} = \frac{{b}_{d}^{{α}_{b}}}{{b}_{c}^{{α}_{b}}} {t}_{{c}_{d}} \qquad ( 4 )$$

In Eq. 4, b_{c} is the user input depth of cut, b_{d} and t_{c}_{_{d}} is the depth of cut and the cut time in the database, t_{c}_{_{b}} is the adjusted cut time for the user input depth of cut and α_{b} is the depth of cut compensation factor. With the depth of cut adjustment, the cut time for all the filtered data in the database can be adjusted for a user defined depth of cut value.

The cut time adjustments shown in Eqs. 2, 3, and 4 can be applied simultaneously to adjust the cut time for multiple factors. Similar compensation factors can also be used for tool geometry, e.g., chip breaker and nose radius. The compensation factors can be different for different materials based on machinability ratings. This enables the cut time for every data point for a given tool-material combination to be adjusted for the user inputs. The adjusted cut time can be subsequently used in the clustering analysis 210 to recommend optimal parameters and the associated cut times.

Furthermore, data can also be augmented using insert grades from different suppliers using the material and coating composition. For example, the Sandvik grade CC670 and Greenleaf grade WG300 for machining hard material are both whisker-reinforced ceramic grades. In this case, if the user's preferred vendor is Sandvik and no or few data exist, data for the Greenleaf inserts can be used for calculations. This can be extended by creating a list of grades similar in material and composition from different suppliers.

Finally, machinability values of different materials can also be used to compensate for cut time. As noted, the compensation factors for each parameter can be determined empirically using data, literature reviews, physics-based modeling, or a combination of both.

Outlier Detection

A physics-guided machine learning outlier detection method can be used to detect and remove outliers. This is done using machining knowledge that tool life reduces with cut interruptions, without coolant, and with increases in cutting speed, feed rate, and depth of cut. This information can be incorporated into a machine learning method that identifies data points that do not conform to the machining knowledge. To illustrate, the procedure is as follows. First, methods such as the median absolute deviation, elliptic envelope, isolation forest, or local outlier factor (LOF) can be used to detect outliers. From machining knowledge, the cut time can be reduced with an increase in cut speed, feed rate, and depth of cut. The outliers that conform to the relationship between cut time and process parameters are preserved. An acceptable variability in data can be defined and outliers can be detected and removed based on it.

Data Visualization

Raw data and results from the disclosed analysis can be visualized in a front-end web dashboard. The disclosed data visualization tool provides interactive analytics features. Data analysis results can be complex and may benefit from support to aid understanding. The disclosed data visualization enhances the interpretability of the results. The disclosed interactive visualization can show common factors for each group and differences between the groups. The disclosed visualization provides comprehensive data analytics controls and multiple types of plots and visual representations to show the raw data and analysis results, such as scatter plots or parallel coordinate plots. The visualization methods will provide a way to visualize test data efficiently to quickly identify high-level variables, gaps, trends, and outliers in the database. Through visualization tools, clustering results can be analyzed to understand and gain insight into the inherent hidden data characteristics.

Systems and methods of the present disclosure can control, by a controller submodule, a computer numerical control (CNC) machine based on the clustered and aggregated machining information.

The disclosed technologies use historical in-process data to make machining process parameter recommendations. The disclosed method enables continuous learning and enables near-optimal starting process parameters. The disclosed data visualization module ensures that new data collected from any machining operations is captured and immediately shared with all users. This ensures that a collective experience of users is shared within their group and is used to help select near-optimal machining parameters. As new tools are developed by vendors and tested at machining operations, information can be quickly disseminated for improving machining processes across different operations. This will reduce lag between tooling development and acceptance in industry.

Existing competing technologies focus on modeling and predicting one or two process variables, e.g., tool wear or machining stability, using data for a given tool-material combination for a given setup. If modeling capability exists, these can be used in conjunction with, or in, a subsequent step to further optimize a particular process, after starting with parameters recommended by the described technologies.

The disclosed technologies can be used generally in fields such as Manufacturing and/or IT/Software. More specifically, the disclosed technologies can be used by a tool and equipment distributor, or a large or medium-sized manufacturer to collect data from its operations and use it to progressively optimize its machining operations for improving productivity and reducing machining costs.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. Memory encoding instructions that, when executed by data processing apparatus, cause the data processing apparatus to perform operations comprising:
receiving, in a user interface of an interface submodule, machining information from a user;
accessing, by the interface submodule, machining information in a data store;
filtering, by a filter submodule, the stored machining information based on the user machining information and retrieving, by the interface submodule, the filtered machining information;
detecting, by a data correction submodule, outliers in the retrieved machining information and removing, by the data correction submodule, the detected outliers to obtain corrected machining information;
clustering and aggregating, by a processor submodule, the corrected machining information in accordance with the user machining information;
presenting, in the user interface, the clustered and aggregated machining information; and
controlling, by a controller submodule, a CNC machine based on the clustered and aggregated machining information.

2. The memory of claim 1, wherein the operations further comprise
prior to detecting the outliers and removing the detected outliers, determining, by the interface submodule, that an amount of the retrieved machining information is below a threshold;
in response to the determination,
receiving, in the user interface, additional machining information from the user, and
augmenting, by the interface submodule, the retrieved machining information with some of the stored machining information selected based on the additional machining information; and
performing the operations of detecting the outliers and removing the detected outliers on the augmented machining information.

3. The memory of claim 1, wherein the operations of clustering and aggregating comprise performing a clustering method including one or more of K-means, mean-shift clustering, or expectation-maximization (EM) clustering using Gaussian mixture models.

4. The memory of claim 1, wherein the operation of detecting outliers comprises performing machine learning methods including one or more of median absolute deviation, elliptic envelope, isolation forest, or local outlier factor.

5. The memory of claim 1, wherein the user machining information comprises information on machine, material, coolant, type of cut, current cutting parameters, cut time, parts per tool/insert edge, machine rate, tool/insert edge cost, tool change time, process objective, or constraints.

6. The memory of claim 1, wherein the clustered and aggregated machining information comprises a recommendation of near-optimal starting machining parameters for the user machining information.

7. The memory of any one of 1, wherein the clustered and aggregated machining information comprises a recommendation of machining parameters to meet a machining objective for the user machining information.

8. The memory of claim 7, wherein the operations of clustering and aggregating include obtaining a baseline cost per part.

9. The memory of claim 2, wherein the operation of augmenting includes at least one of adjusting cut time to match the user inputs for the cut interruption using an interruption compensation factor, adjusting cut time to match the user inputs for coolant using a coolant compensation factor, and adjusting depth of cut to match the user inputs for depth of cut using a depth of cut compensation factor.

10. A machining parameter recommendation system for use with a CNC machine to recommend starting parameters for a given machine and material combination, the machining parameter recommendation system comprising:
a machining information database storing machining information for various machine and material combinations;
a user interface configured to receive a machining parameter recommendation request from a user, wherein the machining parameter recommendation request identifies a machine and a material;
a machining parameter recommendation controller configured to receive the machining parameter recommendation request from the user interface, receive machining information from the machining information database related to the machine and the material identified in the machining parameter recommendation request, determine a set of recommended machining parameters, and communicate the set of recommended machining parameters to the CNC machine;
wherein the machining parameter recommendation controller is configured to determine the set of recommended machining parameters according to instructions stored in memory that when executed cause the machining parameter recommendation controller to:
filter the received machining information based on the user machining parameter recommendation request to a set of filtered machining information related to the machine and material identified in the machining parameter recommendation request;
detect outliers in the filtered machining information and remove the detected outliers to obtain corrected machining information;
cluster and aggregate the corrected machining information in accordance with the machining parameter recommendation request;
determine the set of recommended machining parameters based on the clustered and aggregated machining information;
communicate, to the user interface, the set of recommended machining parameters; and
control the CNC machine based on the clustered and aggregated machining information.

11. The machining parameter recommendation system of claim 10 wherein the machining parameter recommendation request includes a set of constraints and the controller is configured to determine the set of recommended machining parameters based on both the clustered and aggregated machining information and the set of constraints.

12. The machining parameter recommendation system of claim 11 wherein the set of constraints includes at least one of a preferred tool supplier and a number of recommendations to be provided by the machining parameter recommendation system.

13. The machining parameter recommendation system of claim 10, wherein the machining parameter recommendation controller is configured to:
determine the set of filtered machining information is below a threshold amount and in response to the determination;
receive additional machining information from the machining information database unrelated to at least one of the machine or material identified in the machining parameter recommendation request; and
augment the machining information based on the additional machining information.

14. The machining parameter recommendation system of claim 13, wherein the controller is configured to augment the machining information by adjusting the additional machining information based on a compensation factor.

15. The machining parameter recommendation system of claim 10, wherein the controller is configured to cluster and aggregate with one or more of K-means, mean-shift clustering, or expectation-maximization (EM) clustering using Gaussian mixture models.

16. The machining parameter recommendation system of claim 10, wherein the controller is configured to detect outliers using machine learning methods including one or more of elliptic envelope, isolation forest, or local outlier factor.

17. The machining parameter recommendation system of claim 10, wherein the machining parameter recommendation request includes machining information relating to coolant, type of cut, current cutting parameters, cut time, parts per tool/insert edge, machine rate, tool/insert edge cost, tool change time, process objective, constraints, or any combination thereof.

18. The machining parameter recommendation system of claim 10, wherein the set of recommended machining parameters based on the clustered and aggregated machining information includes a recommendation of near-optimal starting machining parameters based on the machining parameter recommendation request.

19. The machining parameter recommendation system of claim 10, wherein the set of recommended machining parameters based on the clustered and aggregated machining information includes a recommendation of machining parameters to meet a machining objective for the user machining information.

20. The machining parameter recommendation system of claim 19, wherein the controller is configured obtain a baseline cost per part.
